(19) United States
(12) Patent Application Publication
(10) Pub. No.: US 2006/0065509 A1
(43) Pub. Date: Mar. 30, 2006

(54) Self bleeding system

(75) Inventor: Larry Pritchard, Macomb, MI (US)

Correspondence Address: STERNE, KESSLER, GOLDSTEIN & FOX PLLC, 1100 NEW YORK AVENUE, N.W., WASHINGTON, DC, 20005, US

(73) Assignee: BorgWarner Inc., Auburn Hills, MI (US)

(21) Appl. No.: 11/229,194

(22) Filed: Sep. 16, 2005

Related U.S. Application Data
(60) Provisional application No. 60/613,981, filed on Sep. 28, 2004.

(51) Int. Cl. F16D 25/0638; F16D 25/12

(52) U.S. Cl. 192/85 AA; 192/85 R

(57) ABSTRACT

The present invention is directed to a self-bleed mechanism for a hydraulic system comprising a clutch pack hydraulically actuated by one or more fluid passageways; an elongated cylinder operably connected to the fluid passageways; a piston slidably disposed in the elongated cylinder where the piston controls actuation of the clutch pack by sliding in the elongated cylinder; and a valve connected to the elongated cylinder, wherein air inside of the elongated cylinder is vented through the valve. The valve is a check valve which vents to the general sump and includes a ball which rests in a tapered valve seat, and the ball is held in place with a spring. The piston has a nozzle on an end that unseats said check valve.

### CROSS-REFERENCE TO RELATED APPLICATION

This application claims the benefit of U.S. Provisional Application No. 60/613,981, filed Sep. 28, 2004. The disclosure of which is incorporated herein by reference.

### FIELD OF THE INVENTION

The present invention relates to hydraulic systems that incorporate the use of an automatically operated bleed valve that purges air from the system during operation.

### BACKGROUND OF THE INVENTION

Hydraulic clutches are commonly used in automatic transmissions and transfer cases. These clutches can be actuated in a number of ways, one of which is through the use of an electric motor, along with a hydraulic fluid circuit.

One problem that can occur when using a hydraulic circuit in any type of application is that air can get into the system and affect the hydraulic system performance. Occasionally, the system needs to “bleed off”, this is a process by which the air is purged from the system, so it can resume normal operation. Prior methods of allowing the system to bleed off include the use of a manually operated bleed valve. The manually operated bleed valve is part of a closed loop hydraulic system that can be used to purge air from the system prior to operation. The present invention is an automatically operated bleed valve that changes the system from a closed loop system to an open loop system.

### SUMMARY OF THE INVENTION

The present invention is directed to a self-bleed mechanism for a hydraulic system comprising a clutch pack hydraulically actuated by one or more fluid passageways. The hydraulic system also includes an elongated cylinder operably connected to the fluid passageways. A piston slidably disposed in the elongated cylinder controls actuation of the clutch pack. A valve is connected to the elongated cylinder allowing air inside the elongated cylinder to be vented through the valve.

The bleed valve is a check valve which vents to the general sump and includes a ball which rests in a tapered valve seat, and the ball is held in place with a spring. The piston has a nozzle on an end that unseats the check valve. The valve is at a generally distal end of the cylinder opposite of the piston. The piston is mechanically actuated and is connected to a ball screw through the use of a ball nut so when the ball screw rotates, the nut and piston translate in the elongated cylinder. The ball screw includes a shaft upon which a gear is mounted; the gear is part of a gear train, which drives the ball screw.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a full sectional front view of an electrohydraulic clutch assembly according to the present invention.

FIG. 2 is a full sectional side view of an electrohydraulic clutch assembly according to the present invention.

### DETAILED DESCRIPTION OF THE PREFERRED EMBODIMENTS

The following description of the preferred embodiment(s) is merely exemplary in nature and is in no way intended to limit the invention, its application, or uses.

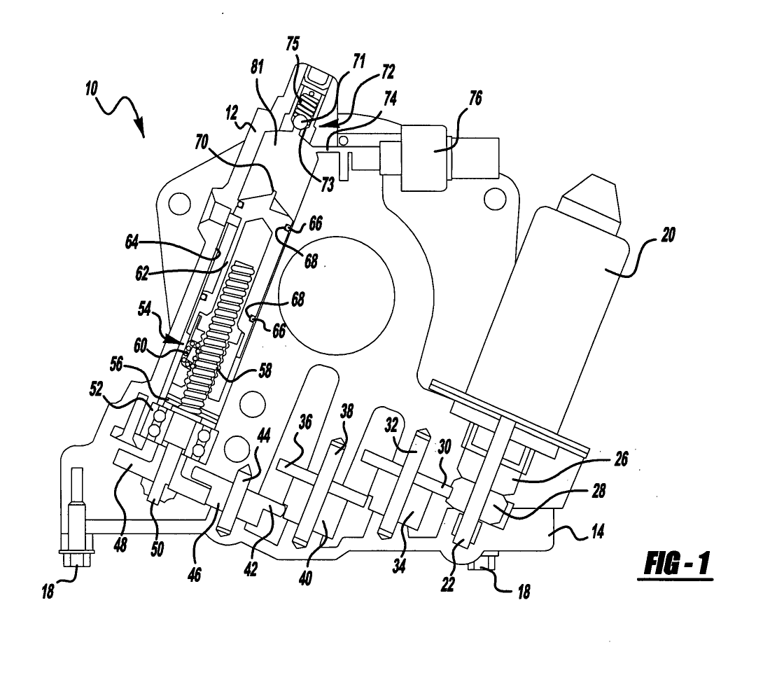

Referring now to FIG. 1 the electrohydraulic clutch assembly 10 includes a preferably metal housing 12 having various bores, ports, slots, faces, passageways for receiving the various components thereof. A first end plate 14 is specially formed to receive various shafts, fits tightly on one end face of the housing 12 and is secured thereby a plurality of fasteners 18. Disposed within a suitably sized region of the housing 12 is a bi-directional, fraction horsepower electric motor 20. The electric motor 20 includes an output shaft 22 and includes a drive hub 26. A driven pinion gear 28 which is freely rotatably disposed on the output shaft 22, is driven by drive hub 26.

The pinion gear 28 is in constant mesh with a first spur gear 30. The first spur gear 30 is supported upon a first shaft 32 and is coupled to or integrally formed with a smaller diameter second pinion gear 34 which is in constant mesh with a second spur gear 36. The second spur gear 36 is likewise rotatably supported upon a second stub shaft 38. The second spur gear 36 is coupled to or preferably integrally formed with a third pinion gear 40. The third pinion gear 40 is in constant mesh with and drives a third spur gear 42. The third spur gear 42 is coupled to or preferably integrally formed with fourth pinion gear 46. The third spur gear 42 is supported by stub shaft 44. The fourth pinion gear 46 is in constant mesh and drives fourth spur gear 48 which is secured to a drive shaft 50.

The drive shaft 50 is preferably supported by a pair of antifriction bearings such as roller bearing assemblies 52. The drive shaft 50 includes a ball screw 54. Between the drive shaft 50 and the ball screw 54 are mounted a plurality of Belleville springs or washers 56 that function as a resilient stop. Disposed about the ball screw 54 is a ball nut 58. The ball nut 58 includes a plurality of balls or roller bearings 60 which recirculate about the complementary configured grooves in the ball screw 54 and thus provide a low friction interconnection between the ball screw 54 and the nut 58. As the shaft 50 bi-directionally rotates in response to bi-directional rotation of the output shaft 22 of the electric motor 20, the ball nut 58 translates as well. The ball screw 54 and the ball nut 58 thus function as a rotary to linear motion transducer.

The ball nut 58 is coupled to a master piston 62 which translates axially within an elongated cylinder 64 which also contains the ball screw 54. The master piston 62 includes a pair of bi-directional seals 66 which are received within suitably configured circumferential grooves 68 near each end of the master piston 62. Between the grooves 68 the cavity filled with fluid or oil. The master piston 62 is shown in FIG. 1 in its retracted position. As the master piston 62 is extended by rotation of the ball screw 54, it forces hydraulic fluid 81 and any air present in elongated cylinder 64 toward the top of elongated cylinder 64. As the master piston 62 reaches the top of elongated cylinder 64, a master cylinder piston nozzle 70 opens a check valve 72, allowing any air trapped in elongated cylinder 64 to escape. The master cylinder piston nozzle 70 is a short projection located on the end of the master piston 62. This configuration allows for electrohydraulic clutch assembly 10 to be self-bleeding. The elongated cylinder 64 is connected to the main oil flow passage 74, which provides for communication and flow of the hydraulic fluid 81 to a pressure transducer 76 that controls the flow of hydraulic fluid 81 to the driven components of the electrohydraulic clutch assembly 10.

It is also possible to bleed air bubbles from the elongated cylinder 64 without having the piston nozzle 70 contact the ball 71, but rather the check valve 72 will be actuated by the buildup of pressure below the seat 73. One way of accomplishing this involves using a spring 75 that has a pre-determined spring rate. For example a spring 75 can be used that will allow the ball 71 to move away from the seat 73 when the pressure below the valve seat 73 reaches a level, without the piston nozzle 70 having to make contact with the ball 71. Another way of arranging the check valve 72 so it can operate without direct contact by the piston nozzle 70 is to control the surface area of the valve seat 73. The surface area of the valve seat 73 can be made smaller so that a smaller surface area of the ball 71 is exposed to the hydraulic pressure below the valve seat 73. The surface area of the ball 71 being exposed though the valve seat 73 will control the amount of hydraulic pressure that will be needed to move the ball 71 away from the valve seat 73.

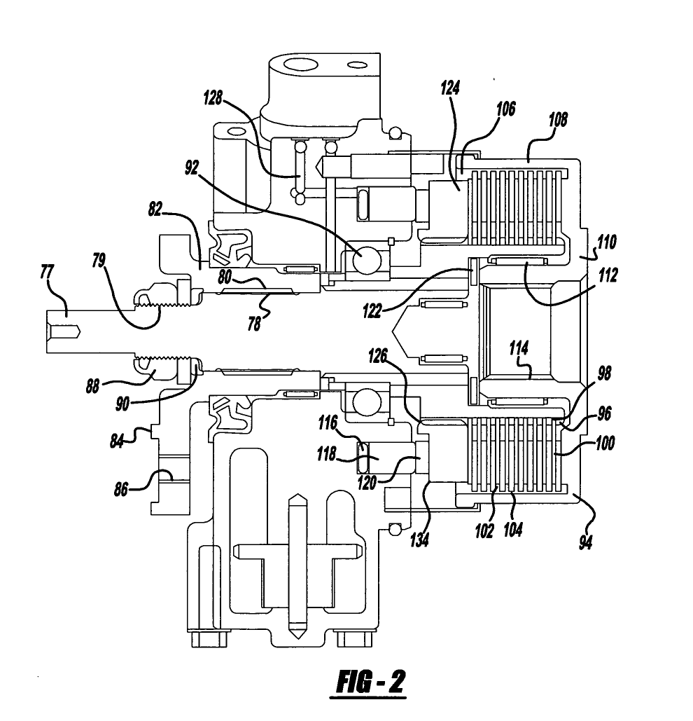

Turning now to FIG. 2, which is a sectional side view of the present invention shown in FIG. 1, the electrohydraulic clutch assembly 10 includes an input member or input shaft 77, preferably including a set of external or male splines or gear teeth 78 and a smaller diameter threaded region 79. The male or external splines or gear teeth 78 are engaged by complementarily configured female splines or gear teeth 80 formed on the interior of a cylindrical region 82 of the flange 84. The flange 84 preferably includes a plurality of through apertures 86 which may receive threaded fasteners or other components (not illustrated) associated with a drive component to the electrohydraulic clutch assembly 10. A retaining nut 88 as well as one or more flat washers 90 may be utilized to positively retain the flange 84 upon the input member or input shaft 77. A roller bearing assembly 92 rotatably supports the input member or input shaft 77 within the housing 12 of the electrohydraulic clutch assembly 10.

The electrohydraulic clutch assembly 10 also includes a multiple plate friction clutch pack assembly 94. Driving the friction clutch pack assembly 94 are a plurality of male or external splines or teeth 96 disposed on the input member or input shaft 77 which engage complementarily configured female splines 98 on the first plurality of smaller diameter friction clutch plates or discs 100. The first plurality of friction clutch plates or discs 100 are interleaved with a second plurality of larger diameter friction clutch plates or discs 102. The friction clutch plate or discs 100 and 102 include suitable clutch paper or friction material in accordance with conventional practice. Each of the second plurality of larger inner diameter friction clutch plates or discs 102 includes male or external splines 104 which engage and drive complementarily configured female splines 106 formed on the interior of a cylindrical portion 108 of a clutch housing 110. The clutch housing 110 is rotationally isolated from and stabilized within a portion of the input member or input shaft 77 by a thrust bearing assembly 112. A thrust bearing assembly 122 is also disposed between the input member or input shaft 77 and the clutch housing 110.

An output member or output shaft 83 preferably includes internal or female splines or gear teeth 114 which are complementary to and engage suitably configured male splines or gear teeth (not illustrated) disposed within the rear differential assembly (not illustrated) which receive torque from the electrohydraulic clutch assembly 10.

The main oil flow passage 74 illustrated in FIG. 1 communicates with second oil flow passage 128 shown in FIG. 2, which feeds the hydraulic fluid 81 into cylinder 116 which receives an annular slave piston 118. The annular slave piston 118 engages a thrust bearing 120 which permits relative rotation between the annular slave piston 118 and thrust bearing plate 134. The thrust bearing plate 134 has an apply area 124, which transfers axial motion and force from the annular slave piston 118 to the friction clutch pack assembly 94. The apply thrust bearing plate 134 includes female or internal splines 126 which are complementary to and engage the male splines 96 on the input member or input shaft 77. Thus, the thrust bearing plate 134 rotates with the input member or input shaft 77.

The operation of the electrohydraulic clutch assembly 10 will now be described with reference to all the drawing figures. A signal is provided to the electric motor 20 commanding it to rotate in one of two directions to increase or decrease the pressure of the hydraulic fluid 81 in main oil flow passage 74, and second oil flow passage 128, and thus the torque transferred through the friction clutch pack assembly 94. If the command is to increase torque, the electric motor 20 rotates in a direction to advance the ball nut 58 and advance the master piston 62 within the elongated cylinder 64. As the master piston 62 translates, hydraulic fluid 81 is transferred, pressure increases and the annular slave piston 118 translates, compressing the friction clutch pack assembly 94. A command for the electric motor 20 to reduce torque transferred through the friction clutch pack assembly 94 results in the opposite action. In this regard, it should also be noted that the pressure transducer 76 provides information regarding the current, actual pressure of the hydraulic fluid 81 which corresponds to a level of torque throughput.

The present invention provides an automatic bleed feature that allows air bubbles built up in the hydraulic fluid 81 located in the elongated cylinder 64 to automatically bleed off through the check valve 72. As the master piston 62 moves toward the check valve 72 air bubbles will migrate toward the check valve 72. The check valve 72 has a ball 71 positioned in a valve seat 73. The valve seat 73 is tapered so when the ball 71 is pressed into the valve seat 73, the ball 71 is directed to a specific position allowing it to become unseated by the master cylinder piston nozzle 70. The ball 71 is held in place at the valve seat 73 by a compression spring 75. When air bubbles build up next to the ball 71 the air will bleed past the ball 71 and valve seat 73. As the master piston 62 moves closer to the check valve 72 the master cylinder piston nozzle 70 will pass through an orifice in the valve seat 73 and make contact with the ball 71. As the master piston 62 continues to move toward the check valve 72 the master cylinder piston nozzle 70 will push against the ball 71 in the check valve 72 and compress the spring 75 to cause the check valve 72 to move to a fully open position thus allowing any air bubbles to be freely bled from the electrohydraulic clutch assembly 10.

The design of the housing 12 as well as the arrangement of components provides a passive oiling or lubrication system to the various components within the electrohydraulic clutch assembly 10. Thus, not only is the need for specific lubricating means such as a pump avoided, but the assembly exhibits improved durability and service life.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A self-bleed mechanism for a hydraulic system comprising:
a clutch pack hydraulically actuated by one or more fluid passageways;
an elongated cylinder operably connected to said one or more fluid passageways;
a piston slidably disposed in said elongated cylinder, wherein said piston controls actuation of said clutch pack by sliding in said elongated cylinder; and
a valve connected to said elongated cylinder, wherein air inside of said elongated cylinder is vented through said valve.

2. The self-bleed mechanism for a hydraulic system of claim 1, wherein said valve is a check valve.

3. The check valve of claim 2, wherein said check valve includes a ball which rests in a tapered valve seat, and said ball is held in place with a spring.

4. The check valve of claim 3, wherein said check valve vents to a general sump.

5. The self-bleed mechanism for a hydraulic system of claim 3, wherein said piston has a nozzle on an end that unseats said check valve.

6. The self-bleed mechanism for a hydraulic system of claim 1, wherein said valve is at a generally distal end of the cylinder opposite said piston.

7. The self-bleed mechanism for a hydraulic system of claim 1, wherein said piston is mechanically actuated.

8. The self-bleed mechanism for a hydraulic system of claim 1, wherein said piston is connected to a ball screw through the use of a ball nut such that as said ball screw rotates, said ball nut and said piston translates in said elongated cylinder.

9. The ball screw of claim 8, wherein said ball screw includes a shaft upon which a gear is mounted, said gear being part of a gear train connected to a motor for driving said ball screw.

10. An electrohydraulic clutch assembly comprising:
an input member and coaxially disposed output member;
a bi-directional electric motor;
a gear train driven by said electric motor;
a ball screw driven by said gear train and driving a master piston moveable within a passage, wherein said master piston displaces hydraulic fluid;
a check valve disposed in said passage; and
a friction clutch pack operably disposed between said input member and said output member and said output member and actuated by said hydraulic fluid.

11. The electrohydraulic clutch assembly of claim 10, wherein said master piston has a nozzle used in conjunction with a check ball assembly; said check ball assembly having a valve seat with a tapered surface for holding a ball, and a spring for pressing said ball against said tapered surface, wherein upon said master piston being fully extended in said passage, said nozzle lifts said ball away from said tapered surface, allowing air trapped in said elongated passage to be released.

12. An electrohydraulic clutch having a self-bleeding mechanism, comprising:
an input shaft selectively coupled to an output shaft through the use of a clutch pack;
a ball screw assembly used for displacing a piston enclosed in a cylinder, with said piston displaces hydraulic fluid in said cylinder;
a series of gears operably associated with said ball screw assembly, and a bi-directional motor; and
an automatic self-bleeding valve assembly operably associated with said cylinder and said piston.

13. The electrohydraulic clutch having a self-bleeding mechanism of claim 12, wherein said ball screw assembly fully actuates said piston, said hydraulic fluid is displaced, causing said clutch pack to fully engage, allowing for full power transfer from said input shaft to said output shaft.

14. The electrohydraulic clutch having a self-bleeding mechanism of claim 12, wherein said piston has a nozzle for actuating said self-bleeding valve.

15. The electrohydraulic clutch having a self-bleeding mechanism of claim 12, wherein said nozzle on said piston actuates said check ball assembly when said ball screw assembly fully actuates said piston.

16. The electrohydraulic clutch having a self-bleeding mechanism of claim 12, wherein said self-bleeding valve is a check ball valve.
